(19) United States
(12) Patent Application Publication
(10) Pub. No.: US 2026/0087353 A1
(43) Pub. Date: Mar. 26, 2026

(54) METHOD FOR ADAPTATION OF A SURROGATE MODEL DESCRIBING A DYNAMIC SYSTEM AND ITS APPLICATION TO SYSTEM OPTIMIZATION

(71) Applicant: NEC Laboratories Europe GmbH, Heidelberg (DE)

(72) Inventors: Makoto TAKAMOTO, Heidelberg (DE); Francesco ALESIANI, Heidelberg (DE)

(21) Appl. No.: 19/111,357

(22) PCT Filed: Jul. 10, 2023
(86) PCT No.: PCT/EP2023/069066

§ 371 Date: Mar. 13, 2025

(30) Foreign Application Priority Data
Sep. 21, 2022 (EP) 22196940.5

(51) Int. Cl. G06N 3/09; G06F 17/13; G06N 3/045

(52) U.S. Cl. CPC G06N 3/09; G06F 17/13; G06N 3/045

(57) ABSTRACT

A computer-implemented method of enabling adaptations of an existing machine learning (ML) model describes a dynamic physical system governed by partial differential equations (PDEs). The method includes building a neural network that is composed of a main neural network modelling the dynamic physical system and a parameter-embedding module for embedding system parameters of the PDEs of the dynamic physical system. The parameter-embedding module is used to train the main neural network over a dataset including a set of experimental and/or simulation data collected over different system parameter configurations. The trained neural network is used for predicting an evolution of the physical system based on a new, yet unseen underlying system parameter configuration. The invention can be employed in medical applications, among others.

### CROSS REFERENCE TO RELATED APPLICATIONS

This application is a U.S. National Phase application under 35 U.S.C. § 371 of International Application No. PCT/EP2023/069066, filed on Jul. 10, 2023, and claims benefit to European Patent Application No. 22196940.5, filed on Sep. 21, 2022. The International Application was published in English on Mar. 28, 2024 as WO 2024/061504 A1 under PCT Article 21(2).

### FIELD

The present disclosure relates to computer-implemented methods and systems for enabling adaptations of an existing machine learning, ML, model describing a dynamic physical system governed by partial differential equations, PDEs.

### BACKGROUND

System optimization is classically performed using either empirical rules or mathematical modelling. However, the former strongly depends on the experience of specific persons/operators and has problems on accuracy; the latter suffers from the problem of finding an appropriate mathematical modelling and huge numerical cost to attain a sufficient accuracy.

The interest on applying machine learning (ML) methods has recently grown as an alternative method to model a system because of its property to capture hidden relations of a system from data. However, the present machine learning approaches are based on the use of a task-specific design of neural-networks and suffer at least i) from not always enabling users to take into account system parameters, so it cannot be used for a parameters optimization, and ii) from not having a universal machine learning model, so that it may be necessary to develop task-specific models every time from the scratch, in particular when system parameters are changed.

A theme in Machine Learning (ML), in particular Scientific Machine Learning (SciML), is the design of machine learning methods capable of predicting the behaviour of a physical system governed by partial differential equations (PDE). These ML-based surrogate models, which are used in place of inefficient and often non-differentiable simulation algorithms, find applications in weather forecasting, molecular dynamics, and medical applications, to name but a few. While a number of ML-based methods for approximating the solutions of PDEs have been proposed in recent years, they typically do not incorporate the parameters of the PDEs under consideration, making it difficult for the ML surrogate models to generalize to PDE parameters not seen during training.

### SUMMARY

In an embodiment, the present disclosure provides a computer-implemented method of enabling adaptations of an existing machine learning (ML) model describing a dynamic physical system governed by partial differential equations (PDEs). The method includes building a neural network that is composed of a main neural network modelling the dynamic physical system and a parameter-embedding module for embedding system parameters of the PDEs of the dynamic physical system, using the parameter-embedding module to train the main neural network over a dataset including a set of experimental and/or simulation data collected over different system parameter configurations, and using the trained neural network for predicting an evolution of the dynamic physical system based on a new, yet unseen underlying system parameter configuration.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating a training process of a CAPE module and a main network in accordance with an embodiment of the present disclosure;

FIG. 2 is a is a schematic view illustrating inference of a parameter embedding and main networks in accordance with an embodiment of the present disclosure;

FIG. 3 is a schematic view illustrating the structure of a CAPE module used in a system in accordance with an embodiment of the present disclosure;

FIG. 4 is a schematic view illustrating a channel-attention process in accordance with an embodiment of the present disclosure;

FIG. 5 is a schematic view illustrating operation of a CAPE module as a conditional network in accordance with an embodiment of the present disclosure;

FIG. 6 is a schematic view illustrating an application scenario of the present invention in the context of cardiovascular disease simulation in accordance with an embodiment of the present disclosure;

FIG. 7 is a diagram schematically illustrating an application scenario of the present invention in the context of modelling water contamination in accordance with an embodiment of the present disclosure;

FIG. 8 is a diagram schematically illustrating an application scenario of the present invention in the context of oil exploration in accordance with an embodiment of the present disclosure; and

FIG. 9 is a diagram illustrating experimental results that compare the performance of the model with the CAPE module with several prior art models in accordance with an embodiment of the present disclosure.

### DETAILED DESCRIPTION

In accordance with an embodiment, the present disclosure improves and further develops a method and a system of the kind described at the beginning in such a way that the above mentioned disadvantages are eliminated or at least mitigated and that the accuracy of the ML model for new parameter configurations of the physical system is improved.

In accordance with another embodiment, the present disclosure provides a computer-implemented method of enabling adaptations of an existing machine learning, ML, model describing a dynamic physical system governed by partial differential equations, PDEs, the method comprising: building a neural network that is composed of a main neural network modelling the physical system and a parameter-embedding module for embedding the system parameters of the PDEs of the physical system; using the parameter-embedding module to train the main neural network over a dataset including a set of experimental and/or simulation data collected over different system parameter configurations; and using the trained neural network for predicting the evolution of the physical system based on a new, yet unseen underlying system parameter configuration.

According to embodiments of the present disclosure, a computer-implemented method is provided that addresses the above-mentioned issues based on a new module which can be combined with any existing ML model. As such, the method allows any existing machine learning model to take into account new system parameters without changing the original model structure. The method not only improves over existing state-of-the-art methods, but also accelerates the process of developing machine learning models to real-world problems, with a small additional memory requirement as the size of the neural network is a little larger than the original neural network because of the parameter-embedding module. In addition, the main neural network input channel is larger than the channel number of the input data. The method according to embodiments disclosed herein can be used for solving an optimization problem of systems with parameters by making use of the gradient descent method in terms of the system parameters. Furthermore, the method according to embodiments disclosed herein can be used for system optimization using digital-twins of the system.

In an embodiment, the present disclosure provides a novel channel-attention-based parameter embedding component (herein also referred to as CAPE module-“Channel-Attention-Parameter-Embedding”) for ML models, in particular scientific ML models. The CAPE module can be combined with any kind of ML surrogate model, enabling these models to adapt to changing PDE parameters without harmful effects on the original model's ability to find approximate solutions to PDEs.

According to an embodiment, the present disclosure provides methods and systems that use a neural-network with the parameter-embedding separated module with respect to the main network that is used to simulate a real-world system, after having been trained on a large dataset of configuration. Specifically, the parameter-embedding module is implemented using channel-attention over multiple filters. This provides the option of fine tuning, as the main network can be possibly trained additionally on a new configuration with new but limited data. Moreover, it provides flexibility, as it can be used (only with slight increase of numerical cost) in connection with any machine learning model. Furthermore, when PDE parameter change, there is no need to modify the original model structure; instead, the main model can just be combined with parameter-embedding module as disclosed herein. It is noted that the original model structure the structure of the main network, which can be a state-of-the-art model structure, such as FNO (for reference, see Zongyi Li et al.: “Fourier neural operator for parametric partial differential equations”, in International Conference on Learning Representations (ICLR), 2021) or U-Net (for reference, see Olaf Ronneberger, Philipp Fischer, and Thomas Brox: “U-Net: Convolutional Networks for Biomedical Image Segmentation”, May 2015).

According to an embodiment, the method disclosed herein may include the steps of
Collecting experimental data and simulation data over different parameters configurations;
Building a new network composed of the CAPE module and the main network;
Training the main neural network with the parameter-embedding module over the dataset; and
Using the trained combined neural network for the new environment (parameters).

The methods and systems according to embodiments of the present disclosure provide at least some of the following advantages:
Increase the accuracy of the model for new parameter configurations,
Speed up the simulation in new configurations,
Provide integrated numerical simulators and observation data,
Estimate parameters of a new system configuration,
Use of hybrid hardware in particular GPU,
Easy Adaptation: The parameter-embedding module can be implemented to any neural-network based machine learning model.

In the context of the present disclosure, the term “dynamic physical system” is to be understand in a broad sense and may include any real-world system having a temporal evolution that can be described by PDEs. In particular, a dynamic physical system may refer to a target system with temporal evolution to be modeled using numerical simulation or a machine learning model.

For instance, to name just one example, the dynamic physical system may relate to a fluid system, wherein the dynamics of hydrodynamic variables (i.e., density, pressure, fluid velocity, or the like) determines the temporal evolution of the system. To simulate such systems, a fixed size numerical box may be set up, which is a virtual “box” for numerical simulations in which the hydrodynamic variables to be calculated are assumed to evolve. Fixed size means that the size of the numerical box does not change during the simulation. It is noted that the simulation size of fluid simulations (i.e. the spatial and temporal resolution used to study the system) can influence the results, and it is customary to use simulation boxes that are large enough to circumvent simulation size effects. In a concrete application scenario, for instance, the simulation of fluid dynamics could relate to a process of climate dynamics, which is very common in weather forecast.

According to embodiments, the parameter-embedding module may be configured to use a channel-attention mechanism that takes an effect or meaning of each of the system parameters embedded by the parameter-embedding module into account individually.

According to embodiments, the channel-attention mechanism may be configured to obtain channel attention by element-wise multiplication of a parameter embedding vector f obtained from the system parameters of the PDEs of the physical system and a feature vector g obtained from experimental and/or simulation data of the physical system. In order to obtain the parameter embedding vector f, it may be provided that the parameter-embedding module includes a number of multi-layer perceptrons, MLPs, wherein the system parameters of the PDEs of the physical system are put into the MLPs and transformed into the parameter embedding vector f. In order to obtain the feature vector g, it may be provided that the parameter-embedding module includes a set of filters with one or more predefined and/or one or more trainable filters, each of which representing a physical process in the physical system. The filters may be used to transform experimental and/or simulation data of the physical system into the feature vector g.

According to embodiments, the filters may include 1×1 convolution, depth-wise convolution, and/or spectral convolution.

According to embodiments, the parameter-embedding module may be further configured to receive system parameters and field data of the physical system at a present time-step and to predict, by using the channel-attention mechanism, an estimate of several time-steps future information of the physical system. The predicted several time-steps future information may then be provided to the main network.

According to embodiments, the parameter-embedding module may be used to calibrate a numerical simulator including the steps of training the parameter-embedding module based on multiple configurations of the numerical simulator, using the trained model as a surrogate model for the numerical simulator, and, upon discovering optimal parameters for a predefined condition, running the numerical simulator with the discovered optimal parameters to obtain a more accurate prediction.

According to embodiments, the parameter-embedding module may be used as a conditional neural network that gets as input the parameters of the physical system and the input of the main network in form of an initial condition, a forcing term or any physics related function. In this context, it may be provided that, during training time, all parameters of the physical system are learned and that, at test/inference time, if data of any new environment are available, only a configurable number of the last layers of the conditional neural network are learned.

There are several ways how to design and further develop the teaching of the present disclosure in an advantageous way. To this end, it is to be referred to the dependent claims on the one hand and to the following explanation of preferred embodiments of the disclosure by way of example, illustrated by the figure on the other hand. In connection with the explanation of the preferred embodiments of the disclosure by the aid of the figure, generally preferred embodiments and further developments of the teaching will be explained. In the drawing

Traditional numerical methods simulate the evolution of a system (as an example one may consider the simulation for the weather forecast) by numerically solving the respective Partial Differential Equations (PDEs) that model the system. On the other hand, for deep neural networks it is possible to learn the behaviour of a numerical simulator, which can be used as a fast and efficient surrogate model of the numerical simulator. However, both methods demand either a full-recalculation or re-training when even one of the system parameters is modified. Alternatively, parameter-embedding modules generally allow to interpolate the configuration of the numerical simulator and help for predicting the output in new ones, whose parameters were not seen before during training.

Embodiments of the present disclosure provide methods and systems that take advantage of a new efficient and effective parameter-embedding module for (scientific) ML. This module, which is sometimes briefly referred to as CAPE module (“Channel-Attention-Parameter-Embedding”) in the present disclosure, makes use of the so-called “channel-attention” mechanism to take the meaning of each parameter, such as the diffusion and advection, into account by the model effectively. According to embodiments, to effectively inform a main network of the embedded parameters, the CAPE module may be configured to predict a rough estimate of several time-steps future information, which the main ML model can make use of to understand the feature of the temporal evolution with the considered parameter. The CAPE module may be flexibly combined with any existing ML models and allows switching the main ML model to the new state-of-the-art model.

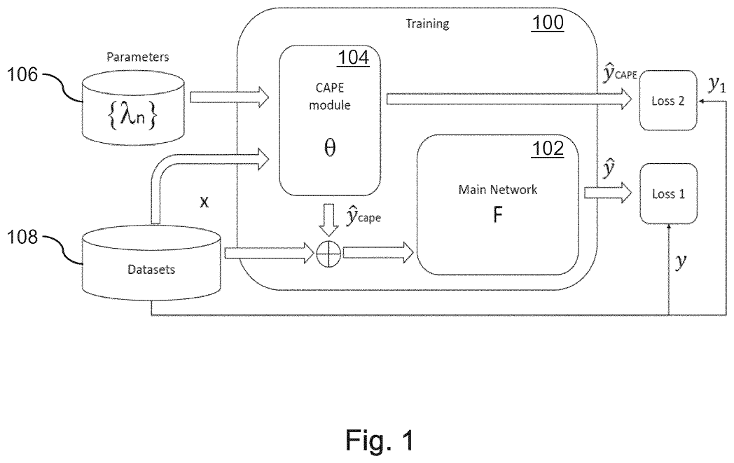

As exemplarily shown in FIG. 1, in an embodiment of the present disclosure provides a neural network 100 for surrogate model adaptation comprising a main network 102 and a parameter-embedding module, i.e. CAPE module 104, that work together. The CAPE module 104 may be configured to accept system parameters λₙ (e.g. from database 106, as shown in FIG. 1) and the field data x at the present time-step (e.g. from database 108, as shown in FIG. 1), and provide the main network 102 with an estimate of a few-step future profile by making use of channel-attention mechanism to effectively take into account the effect of each system parameter.

In general, the main network 102 is the network that sees the input data x and the output ŷCAPE of the CAPE module 104. In an embodiment, it may be provided that those two (i.e., input data x and output ŷ_{CAPE} of the CAPE module 104) are concatenated to create a pseudo-temporal sequential data, which could implicitly provide the main network 102 with the parameter information. Finally, the main network 102 may be configured to predict the 1-step future profile.

According to embodiments of the present disclosure, it may be provided that both the main network 102 and the parameters of the parameter-embedding module's 104 are updated using the stochastic gradient descent

$${θ}^{′} = θ - {∇}_{θ} L ( y , {y}_{1} , \hat{y} , {\hat{y}}_{CAPE} ) )$$

$$where$$

$$L = {W}_{1} {l}_{1} ( y - \hat{y} ( F ( x , θ ( x , λ ) ) ) ) + {w}_{2} {l}_{2} ( {y}_{1} - θ ( x , λ ) )$$

and l₁ is the main loss function and l₂ is an auxiliary loss. w₁ and w₂ are coefficient of the loss functions.

In an embodiment, the CAPE module 104 may be a computational unit which accepts a number of PDE parameters λₙ and an input X^{t}, and maps the information into a form ŷ_{CAPE}(X^{t}, λ) that the main network 102 can understand effectively. Although there are various possible candidates of the mapped information, it turned out that in many scenarios it is easier for the main network 102 to be provided the information in the form of a temporal sequence:

$${\hat{y}}_{CAPE} = \{ {X}_{CAPE}^{t + n} \}$$

where n=±1, ±2, . . . is a hyper-parameter of the module's 104 channel embedding. The output ŷ_{CAPE} of the CAPE module 104 may be regularized by an auxiliary loss as follows:

$${L}_{CAPE} = {\sum }_{n} MSE ( {X}^{t + n} , {\hat{y}}_{CAPE}^{t + n} ( {X}^{t} , λ ) ) ,$$

which regulates the CAPE module 104 to produce a temporal sequence of the input Xₜ. Finally, ŷ_{CAPE} may be concatenated with the input X^{t}, and they may be provided to the main network 102.

In summary, the CAPE module 104 may be configured to transform the input variables: {Xₜ, λ} into temporal-sequential information

$$\{ {X}^{t} , {X}_{CAPE}^{t + n} \} ,$$

which makes it empirically easier for the main network 102 to understand the PDE parameters.

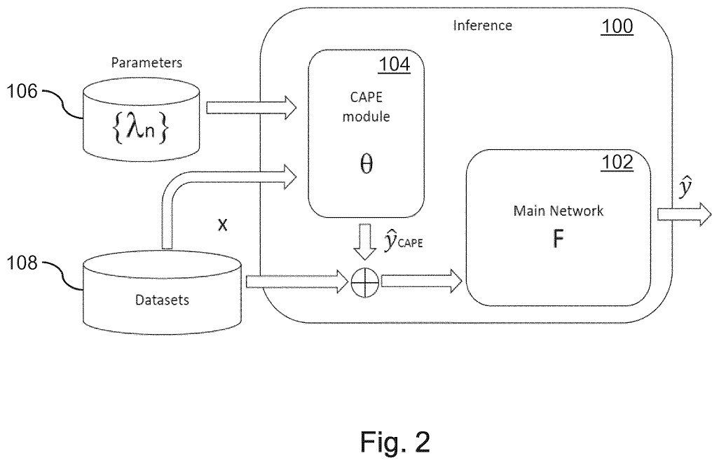

As shown in FIG. 2, wherein like reference numbers denote like components, at inference time, the output of the CAPE module 104 may only be provided to the main network 102.

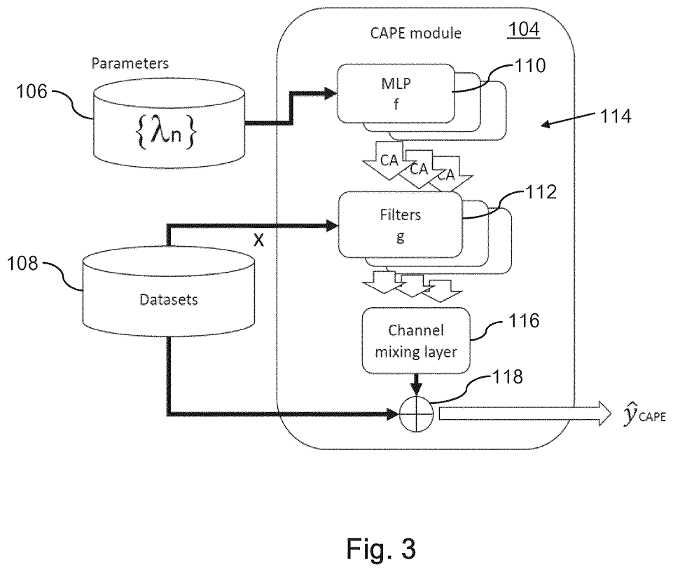

According to an embodiment of the present disclosure, as schematically shown in FIG. 3, the CAPE module 104 may include a set of filters 112 and a channel-attention (CA) mechanism 114. The set of filters 112 may include one or more predefined filters g (e.g., Fourier or wavelet kernel functions) and/or one or more trainable filters (e.g., convolution networks). Each of which can in principle represent some physical processes, such as the advection or diffusion. Accordingly, an appropriate control of the strength of each filter g enables to control the physical process in the PDEs of the respective modelled system.

According to embodiments of the present disclosure, as schematically shown in FIG. 3, in the CAPE module 104 the PDE parameters {λ} may be put into multi-layer perceptrons (MLPs) 110, e.g. 2-layer MLPs, and transformed into an embedding vector, for instance an embedding vector f(λ)∈ [symbol] ^{B×C}, where B, C are batch and channel size, respectively.

Next, the input {X^{t}} may be also transformed into a feature vector g(X^{t})∈ [symbol] ^{B×C×N}, where N is the spatial coordinate dimension. According to an embodiment, the mapping functions g (i.e. the filters 112 in FIG. 3) may include 1×1 convolution, depth-wise convolution, and the spectral convolution. The latter may be realized according to the approach described in Zongyi Li et al.: “Fourier neural operator for parametric partial differential equations”, in International Conference on Learning Representations (ICLR), 2021, the entirety of which is hereby incorporated by reference herein.

Then, the parameter embedding vector f may be multiplied with the feature vector g so as to obtain the channel-attention as follows:

$${\hat{g}}^{B \times C \times N} = {f ( λ )}^{B \times C \times \cdot } \times {g ( {X}^{t} )}^{B \times C \times N} ,$$

where the multiplication is element-wise, and B×C×· means the broadcasting of the vector into the spatial coordinate directions. This is inspired by the squeeze-and-excitation module (as described in Jie Hu et al.: “Squeeze-and-excitation networks”, in Proceedings of the IEEE conference on computer vision and pattern recognition, pp. 7132-7141, 2018 2018, which is hereby incorporated by reference herein), which enhances useful channels of the feature vector of ConvNet by channel attention mechanism. It is noted that in the present case, the convolution operation can be interpreted as a specific physical process because convolution operations accumulate local information of a mesh, which can in principle simulate any local interactions of a fluid, such as advection and diffusion. Hence, the channel-attention process is equivalent to choose appropriate physical processes for each PDE parameters.

Followed by non-linear operation σ, 1×1 convolution may be performed at channel mixing layer 116 on the σ(ĝ) to recover the original channel size, and added to the input X^{t} via residual connection 118. Optionally, performing Layer Normalization on σ(ĝ) before the residual connection 118 can make the training more stable and accurate.

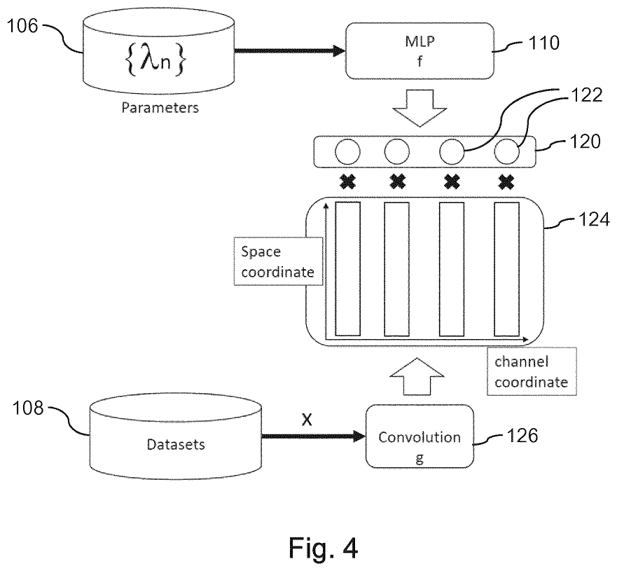

Further details of the channel-attention mechanism according to embodiments of the present disclosure are shown in FIG. 4. Accordingly, the MLP (f) 110 of the CAPE module 104 may be configured to accept the parameters {λₙ} from database 106 and to generate an array 120 with the same number of channels 122 as the number of filters 112 (4 in the exemplarily illustrated embodiment). Then, the generated array 120 may be multiplied with a tensor 124 generated by the filters 112, the tensor 124 having a channel coordinate and a space coordinate as shown in FIG. 4, thereby allowing to control the strength of each filter 112, as discussed above. It should be noted that this process can be regarded as a “channel-attention” because it changes the strength of channels.

As an example, the approach disclosed herein may be applied to hydrodynamic field data. In this context, one may choose, for instance, the depth-wise convolution, 1×1 convolution, and spectral convolution as the trainable filters 112. The MLP 110 may be considered to generate a channel attention array 120 from the parameters {λₙ}. If the number of the channels 122 is modified by the filters 112, the original number of the channels 122 may be recovered by a following 1×1 convolution 126, which may then be mixed with the input X^{t} and provided as the output (ŷ_{CAPE}) of the CAPE module 104, as shown in FIG. 3.

When a new environment is observed, one may not be aware of the parameters of the system. Therefore, according to an embodiment of the present disclosure, it may be provided that only a few samples are used to first detect the parameters of the system and then possibly the same or additional samples are used to update the predictive model that will then be used at test time.

In accordance with an embodiment of the present disclosure, one use of the parameter-embedding module 104 is to calibrate the numerical simulator. In this context, it may be provided that the parameter-embedding module 104 is trained based on multiple configurations of the numerical simulator and then the trained model is used as a surrogate model. Then, the optimal parameters for the desired condition (specific output) are found, and the numerical simulator is run with the new discovered parameters to have a more accurate prediction.

In accordance with an embodiment of the present disclosure, the parameter-embedding module 104 may be regarded as a conditional neural network where the network gets as input 1) the parameters of the system (i.e. of the respective PDEs), and 2) the input of the main networks 102 (e.g., an initial condition or a forcing term or other physic related functions).

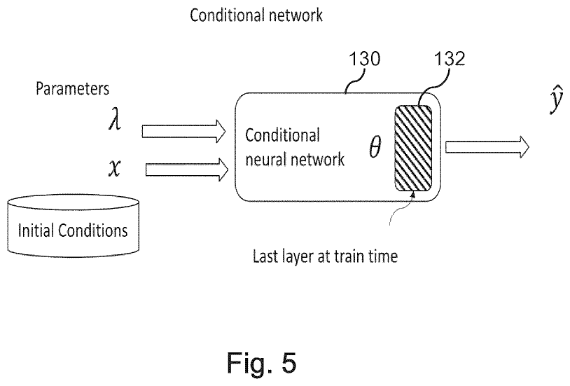

FIG. 5 illustrates an embodiment of the present disclosure in which the CAPE module 104 is operated in the sense of a conditional neural network 130. Here, the parameters λ and the input x (i.e., the initial conditions) feed a single network, i.e. the conditional neural network 130.

In this context, it may be provided that during training time all parameters are learned, but at test/inference time, if data of any new environment are available, only the last layer 132 of the conditional neural network 130 is learned (or a configurable number of last layers). In this way, the training effort is limited at test/inference time; however the advantage in memory size is lost.

Hereinafter, some application scenarios of the methods and systems disclosed herein will be described. As will be appreciated by those skilled in art, the described application scenarios are only exemplary and many other application scenarios in a variety of different technological fields can be realized likewise.

### Molecular Simulation for New Material and New Protein Discovery

In a concrete application scenario, a numerical simulator may use a model for the molecular and atomic interaction in a given system at small scales and may produce a prediction based on these models. However, small errors or unmodeled dynamics can lead to a prediction that is not in line with the observations. In this scenario, where the temporal evolution of atoms/molecules constitutes the dynamic physical target system, a parameter-embedding module 104 in accordance with embodiments of the present disclosure can be used to 1) model the hyper-parameters of the numerical simulation and find the most appropriate configuration for the numerical simulator, and 2) train the parameter-embedding module 104 on a specific calibrated configuration and observational data to predict the output anew on new unseen configurations. An example could be the temperature as parameter, to name just one.

### Cardiovascular Disease Simulation and Identification

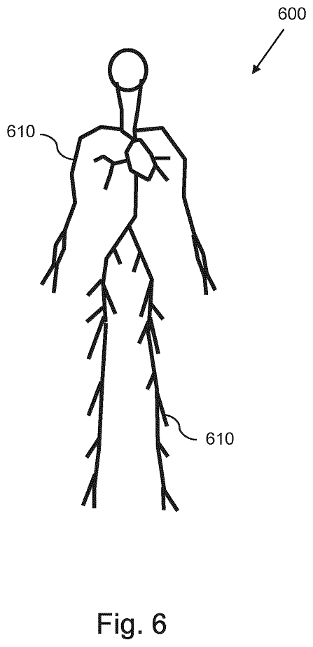

In a further application scenario, the problem of modelling the cardiovascular blood flow may be considered. Consequently, in this case, the dynamic physical system governed by PDEs is the cardiovascular system, wherein the cardiovascular blood flow determines the temporal evolution of the system. As schematically shown in FIG. 6, this can be modelled as a network 600 of linear elements or segments 610 representing the veins and arteria of the cardiovascular system, where each segment 610 of the network 600 obeys the Navier Stokes equation (A)

$${δ}_{t} A ( x , t ) + {δ}_{x} A ( x , t ) u ( x , t ) = 0$$

$${δ}_{t} u ( x , t ) + u ( x , t ) {δ}_{x} u ( x , t ) + \frac{1}{ρ} p ( x , t ) = 0$$

$$p ( x , t ) - {P}_{external} ( x , t ) - β ( \sqrt{A ( x , t )} - \sqrt{{A}_{0}} ) = 0$$

where β=\sqrt{π}h₀E/((1−v²)A₀) with p(x,t), u(x,t), A(x,t), A₀, pₑₓₜ v, ρ denoting the pressure, the fluid velocity, the arterial vessel's cross-section area, the vessel's cross-section area at equilibrium, the external pressure, the Poisson ratio and the density of the blood. x and t represent the spatial and temporal coordinate in each vessel, respectively.

At each bifurcation of the cardiovascular blood flow, the conservation of the momentum and the mass gives the following equations (B)

$${\sum }_{j ∈ {N}_{i}} {A}_{j} {u}_{j} = 0$$

$${p}_{i} + \frac{1}{2} ρ {u}_{i}^{2} = {p}_{j} + \frac{1}{2} ρ {u}_{j}^{2} , ∀ j ∈ {N}_{i}$$

The equation (B) contains multiple parameters. By using a model in accordance with embodiments disclosed herein and building a generalizable model, it is possible to simulate/predict the flow in the future and for different parameters. The prediction may then be used to detect anomalies in the flow and support diagnosis.

Identification of Gene Regulatory Network from Observational Data

In a further exemplary application scenario, a gene regulatory network may be considered that describes the interaction (promotion or inhibition) of gene activity and includes the interaction between genes, other genes and proteins, or other cell elements. The gene regulatory network may be used to model causal relationships among these elements. Partial differential equations can be used to describe the interactions of the genes and proteins. A final expression level can be partially observed using different measure techniques, like gene sequencing. Consequently, in this scenario, the dynamic physical system is a gene regulatory network with a temporal evolution of genes.

According to an embodiment of the present disclosure, by way of training from observational data, the structure and the parameter of the partial differential equations may be derived. The derived model may then be used to detect changes in the gene regulatory network and to measure the consistency of the expression with the specific gene regulatory network for detection of out of distribution.

### Inverse Problem for Water Contamination and Oil Exploration

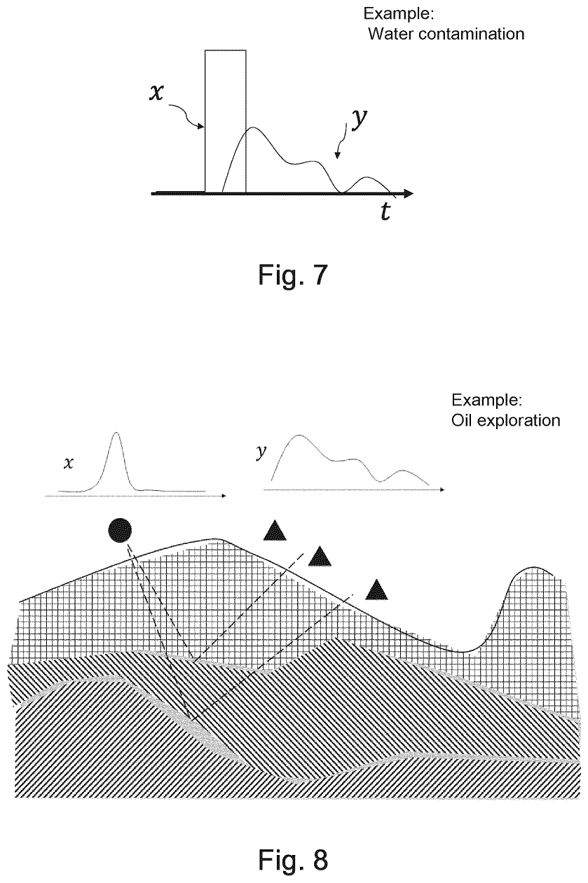

Further exemplary application scenario may be designed to consider the problem of water contamination/pollution (as addressed in Azade Jamshidi et al.: “Solving inverse problems of unknown contaminant source in groundwater-river integrated systems using a surrogate transport model-based optimization”, in Water 12, no. 9 (2020): 2415), see FIG. 7, and oil exploration, see FIG. 8.

FIG. 7 schematically illustrates propagation of a water pollution over time. Specifically, the input of the polluting substance into the water body is described by x(t), while the observed downstream pollution is described by y(t). There can be multiple situations parametrized, for example, by the speed of the water or the water level of the river. Likewise, FIG. 8 schematically illustrates a process of emission and observation of a sound wave for oil exploration. A sound wave is emitted (see filled circle in FIG. 8), wherein the emission is described by x(t), and its propagation, described by y(t), is observed with some sensors (as indicated by the filled triangles in FIG. 8). Different configurations are possible. According to an embodiment, the respective model can be trained on a simulated environment and then deployed in a real situation.

In both cases, the propagation of the pollution or the acoustic wave can be described by a partial differential equation. Thus, the dynamic physical system relates to a temporal evolution of waves under the ground. According to an embodiment, the parameter-embedding module as disclosed herein and numerical simulation can be used in conjunction to estimate the propagation profile of the pollution or the wave, considering, for example, porosity and/or topology of the given domain.

Several machine learning models are trained and tested: e.g. U-Net and FNO with the datasets provided in PDEBench (see Takamoto et al.: “PDEBench: A diverse and comprehensive benchmark for scientific machine learning, 2022, URL https://darus.uni-stuttgart.de/privateurl.xhtml?token=1be27526-348a-40ed-9fd0-c62f588efc01) with various PDE parameters for 1D Advection equation, 1D Burgers equation, and 2D compressible Navier-Stokes equations. For the 1-dimensional PDEs, N=9000 training instances were used and 1000 test instances for each PDE parameters with resolution 128. For the 2-dimensional Navier-Stokes equations, N=900 training instances were used and 100 test instances for each PDE parameters with resolution 64.

As a comparison, those models were trained as (1) vanilla model, (2) with PINO loss (for reference, see Zongyi Li et al.: “Physics-informed neural operator for learning partial differential equations”, arXiv preprint arXiv: 2111.03794, 2021), (3) with past 2-step as input, and (4) with the CAPE module as disclosed herein. Other than case (3), only the initial condition were provided to the models, so the models cannot obtain PDE parameters' information from data, in particular, the vanilla models. The PINO loss function regularizes ML models prediction to follow the PDEs, and can provide a better generalization ability of the models for the trained PDE parameters. The case with CAPE model, the CAPE model was configured to provide one-step future prediction to the main models. On the other hand, the case (3) provide the models with one-step past information as an input. Note that the amount of information provided to the main network of the case (3) and (4) can be the same if the training of CAPE worked, though the temporal direction is opposite (past and future). So, in the following the performance of the case (3) is considered as a baseline of CAPE performance.

Because the solutions of each PDE are not normalized, the performance was measured by the normalized MSE defined as:

$$nMSE = \frac{{‖ {u}_{pred} - {u}_{true} ‖}_{2}}{{‖ {u}_{true} ‖}_{2}} ,$$

where ∥u∥₂ is the L₂-norm of a (vector-valued) variable u, and uₜᵣᵤₑ, u_{pred} are true and predicted value, respectively. Note that in general a naive normalization can change the considering PDE if the PDE is non-linear one.

The normalized MSE loss function L_{nMSE} was used with the auxiliary loss function for the CAPE module L_{CAPE}: L=L_{nMSE}+αL_{CAPE}, where a is the weight coefficient. The optimization was performed with Adam optimizer for 100 epochs. The learning rate was divided by 2 every 20 epochs. For a fair comparison, the model size was made as equally as possible.

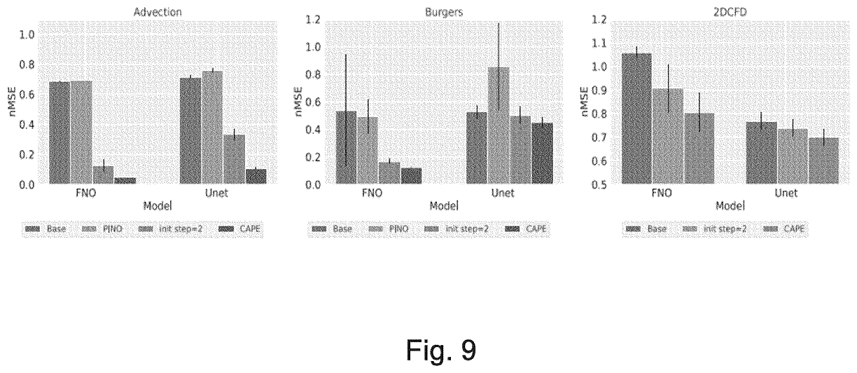

FIG. 9 are the plots of comparing the model with the CAPE module in accordance with the present disclosure with the vanilla models, the models with PINO loss, and the models with including initial 2-step as the initial condition. It shows that the CAPE module provides the best performance in all cases. In particular, the CAPE module provides a significant error reduction, from 20% (2D NS equation) to 95% (1D Advection). This can partly be attributed with the main network's ability of capturing the background physical phenomena from data. Note that FNO is the present state-of-the-art model, and can understand physical operation much better than U-net. Interestingly, the CAPE module provides either comparable or a little better results than the case with inputting initial 2-step information. This indicates that the CAPE module succeeded in providing an equivalent and even more useful information to the main network.

Many modifications and other embodiments of the disclosure set forth herein will come to mind to the one skilled in the art to which the disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the disclosure is also to be considered illustrative or exemplary and not restrictive as the disclosure is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method of enabling adaptations of an existing machine learning; (ML), model describing a dynamic physical system governed by partial differential equations; (PDEs), the method comprising:
building a neural network that is composed of a main neural network modelling the dynamic physical system and a parameter-embedding module for embedding system parameters of the PDEs of the dynamic physical system;
using the parameter-embedding module to train the main neural network over a dataset including a set of experimental and/or simulation data collected over different system parameter configurations; and
using the trained neural network for predicting an evolution of the dynamic physical system based on a new, yet unseen underlying system parameter configuration.

2. The method according to claim 1, wherein the parameter-embedding module uses a channel-attention mechanism that takes an effect of each of the system parameters embedded by the parameter-embedding module into account individually.

3. The method according to claim 2, wherein the channel-attention mechanism obtains channel attention by element-wise multiplication of a parameter embedding vector f obtained from the system parameters of the PDEs of the dynamic physical system and a feature vector g obtained from experimental and/or simulation data of the dynamic physical system.

4. The method according to claim 3, wherein the parameter-embedding module includes a number of multi-layer perceptrons (MLPs), wherein the system parameters of the PDEs of the dynamic physical system are put into the MLPs and transformed into the parameter embedding vector f.

5. The method according to claim 3, wherein the parameter-embedding module includes a set of filters with one or more predefined and/or one or more trainable filters, each of which representing a physical process in the dynamic physical system, wherein the filters are used to transform experimental and/or simulation data of the dynamic physical system into the feature vector g.

6. The method according to claim 5, wherein the filters include 1×1 convolution, depth-wise convolution, and/or spectral convolution.

7. The method according to claim 2, further comprising:
receiving, by the parameter-embedding module, system parameters and field data of the dynamic physical system at a present time-step;
predicting, by using the channel-attention mechanism, an estimate of several time-steps future information of the dynamic physical system; and
providing the predicted several time-steps future information to the main neural network.

8. The method according to claim 1, further comprising using the parameter-embedding module to calibrate a numerical simulator comprising the steps of:
training the parameter-embedding module based on multiple configurations of the numerical simulator;
using a trained model as a surrogate model for the numerical simulator; and
upon discovering optimal parameters for a predefined condition, running the numerical simulator with the discovered optimal parameters to obtain a more accurate prediction.

9. The method according to claim 1, further comprising:
using the parameter-embedding module as a conditional neural network that gets as input the parameters of the dynamic physical system and the input of the main neural network in form of an initial condition, a forcing term or any physics related function.

10. The method according to claim 9, further comprising:
learning, during training time, all parameters of the dynamic physical system; and
learning, at test/inference time, based on data of any new environment being available, only a configurable number of the last layers of the conditional neural network.

11. A system for enabling adaptations of an existing machine learning (ML), model describing a dynamic physical system governed by partial differential equations (PDEs), the system comprising one or more processors that, alone or in combination, are configured to provide for the execution of the following steps:
building a neural network that is composed of a main neural network modelling the dynamic physical system and a parameter-embedding module for embedding system parameters of the PDEs of the dynamic physical system;
using the parameter-embedding module to train the main neural network over a dataset including a set of experimental and/or simulation data collected over different system parameter configurations; and
using the trained neural network for predicting an evolution of the dynamic physical system based on a new, yet unseen underlying system parameter configuration.

12. The system according to claim 11, wherein the parameter-embedding module includes a channel-attention mechanism configured to take an effect of each of the system parameters embedded by the parameter-embedding module into account individually,
wherein the channel-attention mechanism may be further configured to obtain channel attention by element-wise multiplication of a parameter embedding vector f obtained from the system parameters of the PDEs of the dynamic physical system and a feature vector g obtained from experimental and/or simulation data of the dynamic physical system.

13. The system according to claim 12, wherein the parameter-embedding module includes a number of multi-layer perceptrons, MLPs, configured to receive the system parameters of the PDEs of the dynamic physical system and to transform the received system parameters into the parameter embedding vector f.

14. The system according to claim 12, wherein the parameter-embedding module includes a set of filters with one or more predefined and/or one or more trainable filters, each of which representing a physical process in the dynamic physical system, wherein the filters are configured to transform experimental and/or simulation data of the dynamic physical system into the feature vector g.

15. A tangible, non-transitory computer-readable medium having instructions thereon which, upon being executed by one or more processors, alone or in combination, provide for execution of a method enabling adaptations of an existing machine learning (ML) model describing a dynamic physical system governed by partial differential equations (PDEs), the method comprising:
building a neural network that is composed of a main neural network modelling the dynamic physical system and a parameter-embedding module for embedding system parameters of the PDEs of the dynamic physical system;
using the parameter-embedding module to train the main neural network over a dataset including a set of experimental and/or simulation data collected over different system parameter configurations; and
using the trained neural network for predicting an evolution of the dynamic physical system based on a new, yet unseen underlying system parameter configuration.
